(19) United States
(12) Patent Application Publication
(10) Pub. No.: US 2019/0074616 A1
(43) Pub. Date: Mar. 7, 2019

(54) ELECTRICAL PLUG CONNECTOR AND ELECTRICAL RECEPTACLE CONNECTOR

(71) Applicant: Advanced Connectek Inc., New Taipei City (TW)

(72) Inventors: Pin-Yuan HOU, New Taipei City (TW); Wen-Hsien TSAI, New Taipei City (TW); Shuang-Xi XIAO, New Taipei City (TW)

(73) Assignee: Advanced Connectek Inc., New Taipei City (TW)

(21) Appl. No.: 16/116,498

(22) Filed: Aug. 29, 2018

(30) Foreign Application Priority Data
Sep. 1, 2017 (CN) 201710777054.2

(51) Int. Cl. H01R 12/71; H01R 12/58; H01R 13/627; H01R 12/70; H01R 12/73; H01R 13/639; H01R 13/11; H01R 13/05

(52) U.S. Cl. CPC H01R 12/716; H01R 12/585; H01R 13/627; H01R 13/055; H01R 12/73; H01R 13/639; H01R 13/113; H01R 12/7064

(57) ABSTRACT

An electrical plug connector has an insulated housing, two elastic buckle elements, multiple plug terminals, and a plug metallic shell. The insulated housing has a terminal portion and two connecting portions. The two elastic buckle elements are respectively mounted in receiving grooves of the two connecting portions of the insulated housing. Multiple plug terminals are arranged on the terminal portion of the insulated housing. An electrical receptacle connector is detachably connected with the electrical plug connector. The electrical receptacle connector has a receptacle insulated housing and multiple receptacle terminals. The receptacle insulated housing has an inserting portion and two receptacle connecting portions. The multiple receptacle terminals are mounted in a mounting slot of the receptacle insulated housing. When the electrical plug connector is connected with the electrical receptacle connector, the multiple plug terminals may contact the multiple receptacle terminals and are conducted.

### BACKGROUND OF THE INVENTION

### 1. Field of the Invention

The instant disclosure relates to a connector, and more particularly to an electrical plug connector that is coupled to a coaxial cable or a flexible flat cable (FFC) and an electrical receptacle connector that is mounted on a circuit board or a flexible printed circuit (FPC).

### 2. Description of Related Art

An electrical plug connector and an electrical receptacle connector are used to connect different electrical components. The electrical plug connector is coupled to a coaxial cable or a flexible flat cable (FFC), and the electrical receptacle connector is mounted on a circuit board or a flexible printed circuit (FPC). Therefore, the coaxial cable may be electrically connected with the circuit board.

However, after the conventional electrical plug connector is inserted into the electrical receptacle connector, the conventional electrical receptacle connector needs a ring-shaped buckle to connect with the conventional electrical plug connector to secure the connection between the conventional electrical receptacle connector and the electrical plug connector. However, the conventional electrical receptacle connector and the conventional electrical plug connector have the following drawbacks.

First, there is no guiding device between the conventional electrical plug connector and the conventional electrical receptacle connector. Therefore, a user has to align the conventional electrical plug connector and the conventional electrical receptacle connector carefully.

Second, after the conventional electrical plug connector is inserted into the conventional electrical receptacle connector, the user needs to lock the buckle, and this is inconvenient for the user.

Third, the ring-shaped buckle is an independent component from the electrical receptacle connector. Therefore, the whole structure is complicated, and the cost cannot be reduced.

Fourth, the electrical receptacle connector may be used in environments with electromagnetic interference (EMI) and radio frequency interference (RFI), but the conventional electrical receptacle connector is not effective in preventing the aforementioned interference.

### SUMMARY OF THE INVENTION

The instant disclosure is to provide an electrical plug connector and an electrical receptacle connector that can be easily mutually mating and dissembled from each other with a guiding mechanism.

In view of this, an embodiment of the instant disclosure provides an electrical plug connector which has an insulated housing, two elastic buckle elements, multiple plug terminals, and a plug metallic shell. The insulated housing has a terminal portion and two connecting portions. The two elastic buckle elements are respectively mounted in receiving grooves of the two connecting portions of the insulated housing. The multiple plug terminals are mounted at the terminal portion of the insulated housing. An electrical receptacle connector is detachably connected with the electrical plug connector. The electrical receptacle connector has a receptacle insulated housing and multiple receptacle terminals. The receptacle insulated housing has an inserting portion and two receptacle connecting portions. The multiple receptacle terminals are mounted in a mounting slot of the receptacle insulated housing. When the electrical plug connector is connected with the electrical receptacle connector, the multiple plug terminals may contact the multiple receptacle terminals and are electrically connected.

Other objects, advantages, and novel features of the instant disclosure will become more apparent from the following detailed description when taken in conjunction with the accompanying drawings.

### BRIEF DESCRIPTION OF THE DRAWINGS

FIG. 1 is a perspective view of an electrical plug connector and an electrical receptacle connector in accordance with the instant disclosure;

FIG. 2 is an exploded perspective view of the electrical plug connector and the electrical receptacle connector in FIG. 1;

FIG. 3 is another exploded perspective view of the electrical plug connector and the electrical receptacle connector in FIG. 1;

FIG. 4 is another exploded perspective view of the electrical plug connector and the electrical receptacle connector in FIG. 1;

FIG. 5 is an exploded perspective view of the electrical plug connector in FIG. 1;

FIG. 6 is an exploded perspective view of the electrical receptacle connector in FIG. 1;

FIG. 7 is an enlarged operational cross sectional side view of the electrical plug connector and the electrical receptacle connector in FIG. 1;

FIG. 8 is another enlarged operational cross sectional side view of the electrical plug connector and the electrical receptacle connector in FIG. 1; and

FIG. 9 is an enlarged exploded operational cross sectional side view of the electrical plug connector and the electrical receptacle connector in FIG. 1.

### DETAILED DESCRIPTION OF PREFERRED EMBODIMENT

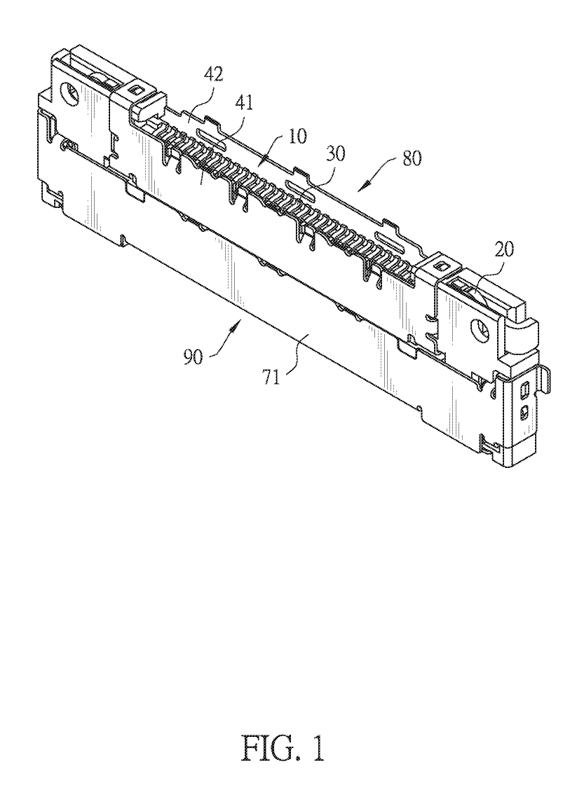

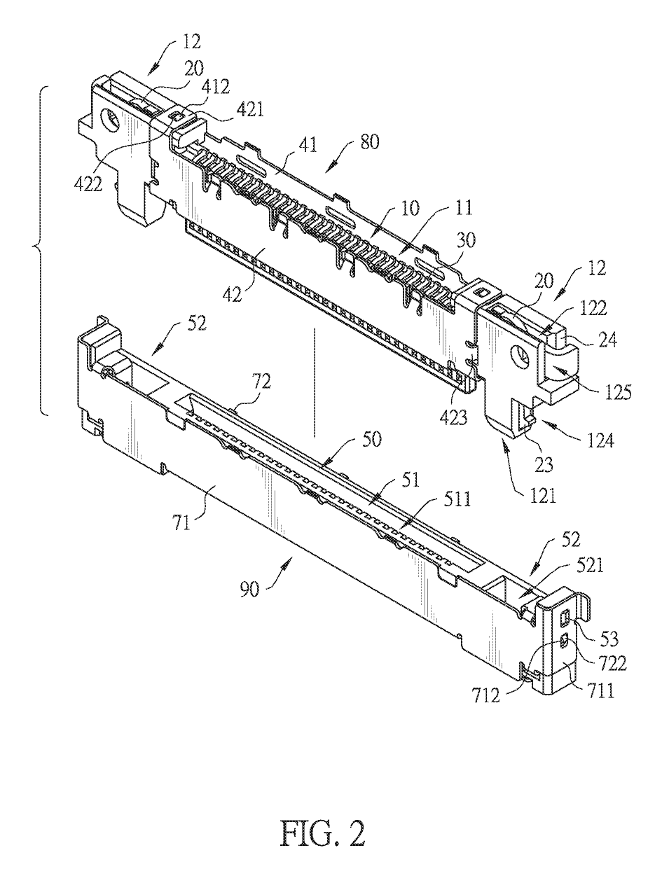

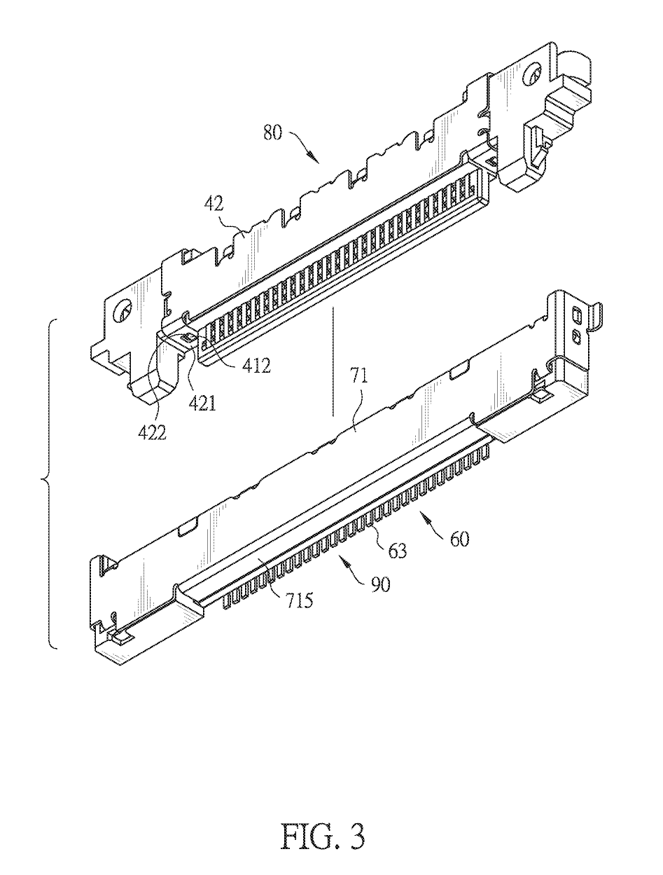

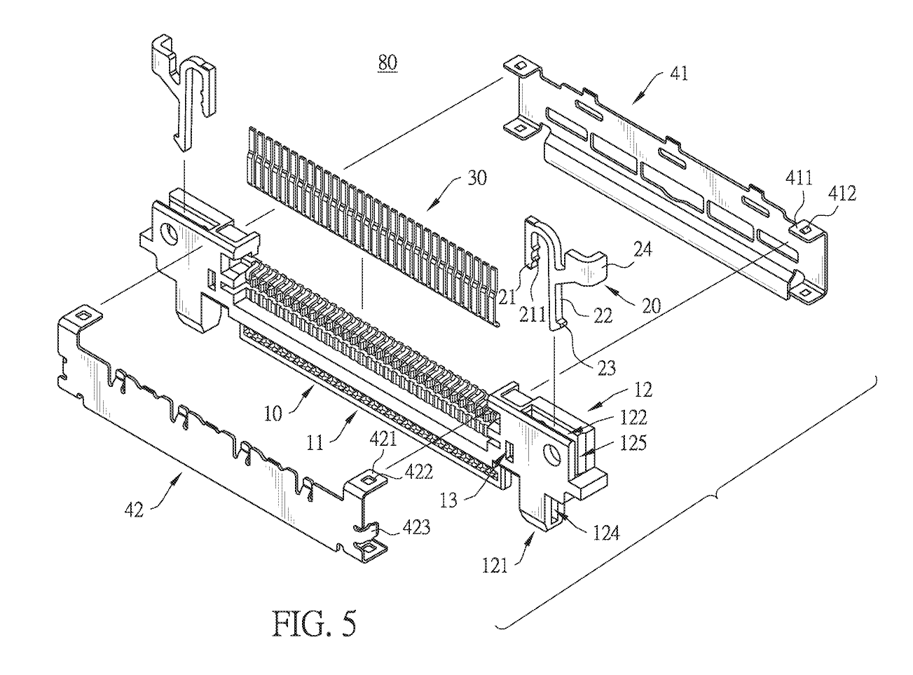

Referring to FIGS. 1 and 2, the instant disclosure provides an electrical plug connector 80 and an electrical receptacle connector 90. With reference to FIGS. 2 to 5 and 9, the electrical plug connector 80 has an insulated housing 10, two elastic buckle elements 20, multiple plug terminals 30, and a plug metallic shell.

The insulated housing 10 has a terminal portion 11 and two connecting portions 12 which are formed in long-and-thin shapes. The terminal portion 11, which is formed in a long-and-thin shape, has a first end and a second end. The two connecting portions 12 are respectively formed at the first end and the second end of the terminal portion 11. Each connecting portion 12 has a guiding pillar 121. The guiding pillar 121 protrudes from a bottom surface of the connecting portion 12. Preferably, each guiding pillar 121 is a rectangular pillar. Each guiding pillar 121 has four inclined faces formed at a bottom surface of the guiding pillar 121, and this makes the guiding pillar 121 tapered from the top to the bottom. Therefore, the four inclined faces of each guiding pillar 121 can provide a guiding effect. The shape of the each guiding pillar 121 is not limited to a rectangle; for instance, the bottom of each guiding pillar 121 may be a hemisphere.

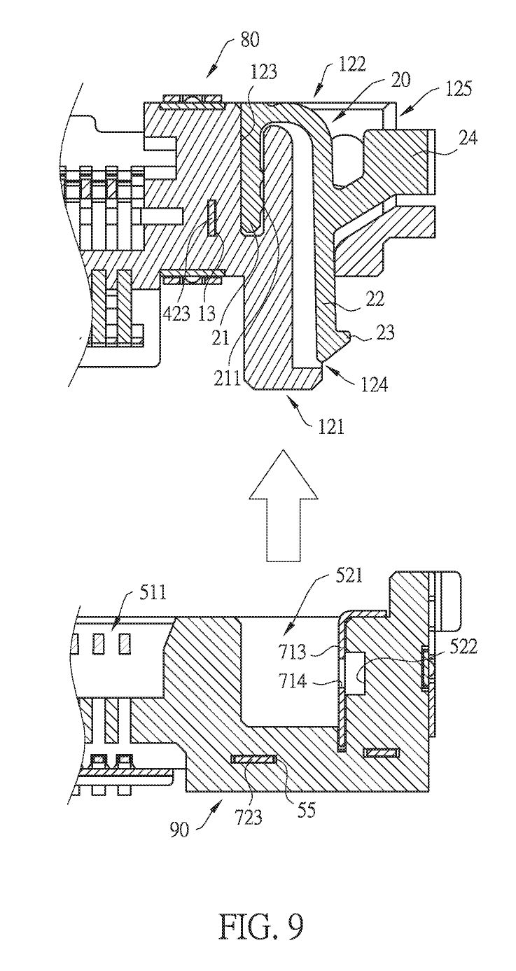

Each connecting portion 12 has a receiving groove 122 and a fixing groove 123 (as shown in FIG. 9), and the receiving groove 122 and the fixing groove 123 are formed in a top surface of the connecting portion 12. The receiving groove 122 extends to the internal space of the guiding pillar 121. The guiding pillar 121 has a side surface and an opening 124, and the opening 124 is formed through the side surface of the guiding pillar 121 and communicates with the receiving groove 122. In this embodiment, the opening 124 is formed on the outer side surface of the guiding pillar 121. The opening 124 is not limited to be formed on the outer side surface of the guiding pillar 121 and can be formed on the front or the back side surface of the guiding pillar 121.

The two elastic buckle elements 20 are respectively mounted in the receiving grooves 122 of the two connecting portions 12. Each elastic buckle element 20 has a fixed portion 21, a moving portion 22, an engaging portion 23, and a pressing portion 24. The fixed portion 21 is mounted at the corresponding connecting portion 12. In this embodiment, the fixed portion 21 is mounted through the fixing groove 123. The fixed portion 21 has a side surface and multiple abutting protruding portions 211, and the multiple abutting protruding portions 211 protrude from the side surface of the fixed portion 21 transversely. The multiple abutting protruding portions 211 abut an inner surface of the fixing groove 123, and this makes the fixed portion 21 stably mounted at the connecting portion 12.

A top end of the moving portion 22 is connected with a top end of the fixed portion 21. The moving portion 22 can be pressed and moved toward the fixed portion 21. The engaging portion 23 horizontally protrudes from a bottom end of the moving portion 22. The engaging portion 23 selectively extends from the opening 124 of the guiding pillar 121 according to the position of the moving portion 22. In this embodiment, the engaging portion 23 transversely protrudes from a bottom of the moving portion 22, and this makes the engaging portion 23 extend out of the opening 124 of the guiding pillar 121.

Each connecting portion 12 has a notch 125 formed through a side surface of the connecting portion 12. Each notch 125 communicates with a corresponding receiving groove 122. The pressing portion 24 of each elastic buckle element 20 horizontally protrudes form an outer side surface of the moving portion 22, and extends out of the corresponding notch 125. Therefore, a user may press the moving portion 22 via the pressing portion 24, and the moving portion 22 and the engaging portion 23 are moved toward the fixing groove 123. In another embodiment, there is no pressing portion 24, the moving portion 22 directly extends out of the connecting portion 12, and a user may press the moving portion 22 directly.

The multiple plug terminals 30 are arranged on the terminal portion 11 along a longitudinal direction of the terminal portion 11 so as to form multipolar shapes at appropriate pitch intervals. The long-and-thin shaped terminal portion 11 is extending in a long-and-thin shape along the multipolar arrangement direction (the connector longitudinal direction) of the multiple plug terminals 30. The multiple plug terminals 30 include at least one signal terminal and at least one ground terminal. In another embodiment, the multiple plug terminals 30 include at least one power supply terminal.

The insulated housing 10 is covered by the plug metallic shell. In this embodiment, the plug metallic shell includes a first metallic shell 41 and a second metallic shell 42. The insulated housing 10 is covered by the first metallic shell 41 from above and the second metallic shell 42 from below.

The first metallic shell 41 has two side ends, two first positioning sheets 411, and two first positioning blocks 412. Each first positioning sheet 411 protrudes from a respective one of the two side ends toward the insulated housing 10. The two first positioning sheets 411 are bent to form upper and lower sides of the first metallic shell 41 respectively. Each positioning block 412 protrudes from a top surface of a respective one of the first positioning sheets 411.

The second metallic shell 42 has two side ends, two second positioning sheets 421, and two second positioning holes 422. Each second positioning sheet protrudes from a respective one of the two side ends toward the insulated housing 10. The two second positioning sheets 421 are bent to form upper and lower sides of the second metallic shell 42 respectively. Each second positioning hole 422 is formed through a respective one of the second positioning sheets 421. Each second positioning hole 422 is disposed around a respective one of the positioning blocks 412 of the first metallic shell 41. Therefore, the first metallic shell 41 and the second metallic shell 42 can be combined together.

The insulated housing 10 further has two insertion slots 13, and the two insertion slots 13 are formed in a side surface of the insulated housing 10 that faces the second metallic shell 42. The second metallic shell 42 has two clamping sheets 423 protruding from an inner surface of the second metallic shell 42. The two clamping sheets 423 are respectively mounted in the two insertion slots 13, such that the second metallic shell 42 is combined with the insulated housing 10.

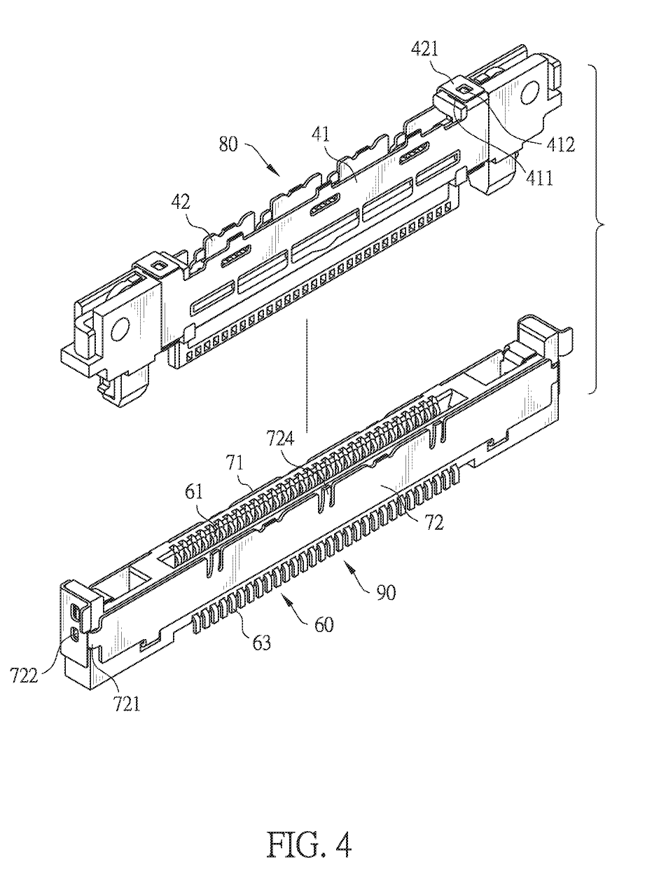

Referring to FIGS. 4, 6, and 9, the electrical receptacle connector 90 is detachably connected with the electrical plug connector 80. The electrical receptacle connector 90 has a receptacle insulated housing 50, multiple receptacle terminals 60, and a receptacle metallic shell.

The receptacle insulated housing 50 has an inserting portion 51 and two socket connecting portions 52 which are formed in long-and-thin shapes. The inserting portion 51 has a mounting slot 511 formed in a top surface of the inserting portion 51. The terminal portion 11 of the insulated housing 10 of the electrical plug connector 80 is detachably mounted in the mounting slot 511.

The inserting portion 51, which is formed in a long-and-thin shape, has a first end and a second end. The two receptacle connecting portions 52 are respectively formed at the first end and the second end of the inserting portion 51 to form the long-and-thin shape. Each receptacle connecting portion 52 has a guiding recess 521 and an engaging recess 522. The guiding recess 521 is formed in a top end of the corresponding receptacle connecting portion 52. The engaging recess 522 is formed in a side wall of the guiding recess 521.

In the embodiment, the engaging recess 522 is located at an inner surface of the guiding recess 521. The engaging recess 522 may be located at a front surface or a back surface of the guiding recess 521.

The two guiding pillars 121 of the electrical plug connector 80 are detachably mounted in the guiding recesses 521 of the two receptacle connecting portions 52. The engaging portions 23 of the two elastic buckle elements 20 detachably engage with the engaging recesses 522 of the two receptacle connecting portions 52.

The multiple receptacle terminals 60 are mounted in the mounting recess 511 of the receptacle insulated housing 50 along a longitudinal direction of the inserting portion 51 so as to form multipolar shapes at appropriate pitch intervals. The long-and-thin shaped inserting portion 51 is extending in a long-and-thin shape along the multipolar arrangement direction (the connector longitudinal direction) of the multiple receptacle terminals 60. The multiple receptacle terminals 60 include at least one signal terminal and at least one grounding terminal. In another embodiment, the multiple receptacle terminals 60 include at least one power supply terminal.

When the electrical plug connector 80 is mated with the electrical receptacle connector 90, the multiple plug terminals 30 may contact the multiple receptacle terminals 60 and are conducted with each other.

The receptacle plug metallic shell is connected with the receptacle insulated housing 50. In this embodiment, the receptacle plug metallic shell includes a third metallic shell 71 and a fourth metallic shell 72. The receptacle insulated housing 50 is covered between the third metallic shell 71 and the fourth metallic shell 72.

Each receptacle connecting portion 52 has a housing positioning block 53 and a positioning recess 54. The housing positioning block 53 protrudes from a side surface of the receptacle connecting portion 52. The positioning recess 54 is formed in the side surface of the receptacle connecting portion 52.

The fourth metallic shell 72 has two side surfaces, two fourth positioning sheets 721, and two fourth positioning blocks 722. The two fourth positioning sheets 721 respectively protrude from the two side surfaces of the fourth metallic shell 72. The two fourth positioning sheets 721 respectively are inserted into the positioning recesses 54 of the two receptacle connecting portions 52. The two fourth positioning blocks 722 respectively protrude from side surfaces of the two fourth positioning sheets 721.

The third metallic shell 71 has two side surfaces, two third positioning sheets 711, and two third positioning holes 712. The two third positioning sheets 711 protrude from the two side surfaces of the third metallic shell 71. The two third positioning holes 712 are respectively formed through the two third positioning sheets 711. Therefore, the third metallic shell 71 and the fourth metallic shell 72 can be combined together.

Furthermore, referring to FIG. 9, the receptacle insulated housing 50 has two receptacle inserting recesses 55. The two receptacle inserting recesses 55 are formed in a side surface of the receptacle insulated housing 50 and face the fourth metallic shell 72. The fourth metallic shell 72 has two lateral-side fixation plates 723. The two lateral-side fixation plates 723 protrude from a bottom edge of the fourth metallic shell 72 and face the receptacle insulated housing 50. The two lateral-side fixation plates 723 are respectively mounted in and fixed with the two receptacle inserting recesses 55, and the fourth metallic shell 72 and the insulated housing 50 can be combined together. In another embodiment, the number of the receptacle inserting recess 55 and the number of the fixed sheet 723 can be one or multiple.

Furthermore, the third metallic shell 71 has two side edges and two engaging sheets 713. The two engaging sheets 713 respectively protrude from the two side edges. The two engaging sheets 713 are respectively mounted in the two guiding recesses 521 of the receptacle insulated housing 50. Each engaging sheet 713 has an engaging hole 714 formed through the engaging sheet 713. The two elastic buckle elements 20 are respectively detachably engaged with the engaging holes 714 of the two engaging sheets 713. Therefore, the connection strength between the electrical plug connector 80 and the electrical receptacle connector 90 is enhanced.

Furthermore, the third metallic shell 71 has a bottom surface and a shelter sheet 715. The shelter sheet 715 protrudes from the bottom surface of the third metallic shell 71, and the shelter sheet 715 is below the multiple receptacle terminals 60. Specifically, each receptacle terminal 60 has an upper extending portion 61, a horizontal portion 62, and a lower extending portion 63. The upper extending portion 61 is upwardly bent at a front end of the horizontal portion 62, and the lower extending portion 63 is bent downwards at a rear end of the horizontal portion 62. The shelter sheet 715 shelters the horizontal portion 62 of each receptacle terminal 60 to block electromagnetic interference (EMI) and radio frequency interference (RFI).

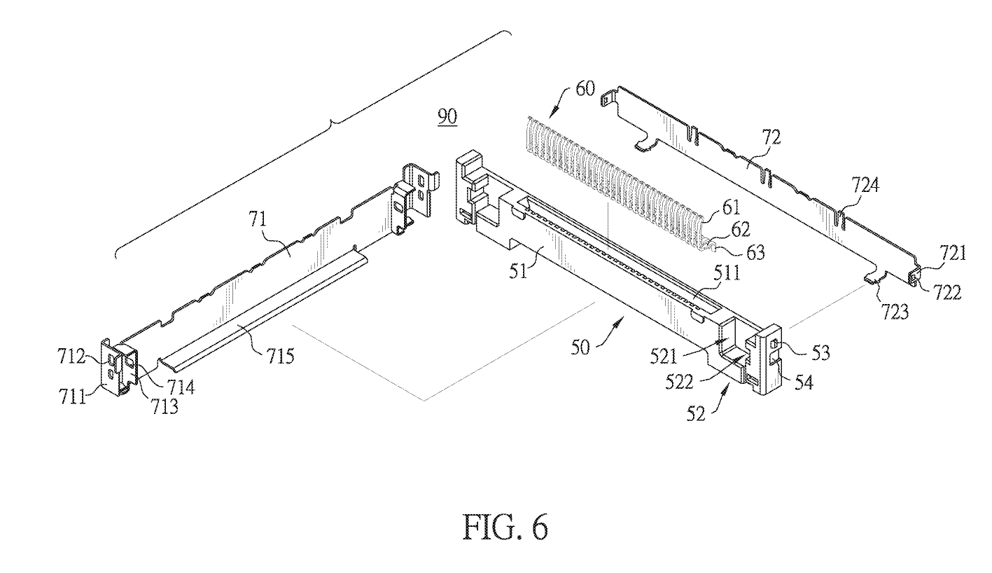

Referring to FIGS. 4 and 6, the fourth metallic shell 72 has a top surface and three grounding sheets 724. The three grounding sheets 724 protrude from the top surface of the fourth metallic shell 72. The grounding sheets 724 can be used to contact the circuit board or the substrate to achieve the grounding effect. In use, the grounding sheets 724 can be optionally bent to connect with the circuit board or the substrate. In other embodiments, the number of the grounding sheet 724 can be one.

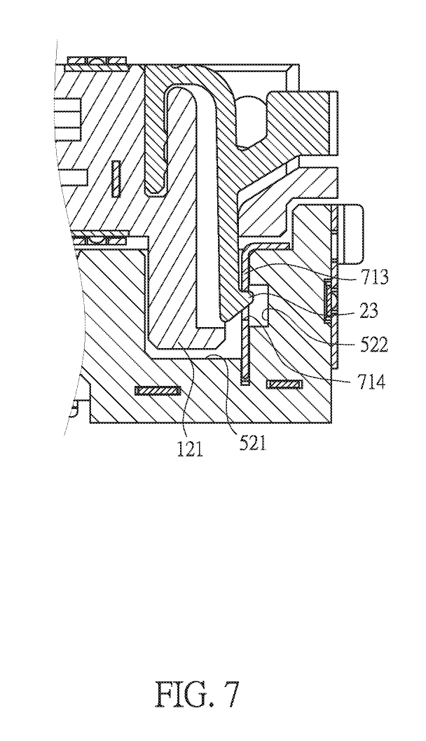

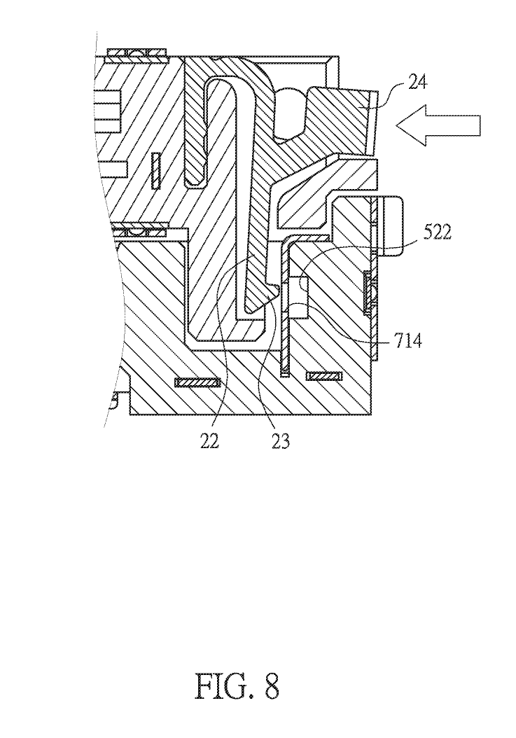

Referring to FIGS. 7 to 9, the electrical plug connector 80 may be plugged in the electrical receptacle connector 90, and the alignment between the two guiding pillars 121 of the electrical plug connector 80 and the two guiding recesses 521 of the electrical receptacle connector 90 can provide a guiding effect to facilitate the assembly of the electrical plug connector 80 and the electrical receptacle connector 90.

In addition, after the two guiding pillars 121 are respectively inserted into the two guiding recesses 521, the engaging portions 23 of the two elastic buckle elements 20 may respectively engage with the two engaging recesses 522, thereby combining the electrical plug connector 80 and the electrical receptacle connector 90 together. When the electrical plug connector 80 is detached from the electrical receptacle connector 90, the pressing portions 24 of the two elastic engaging elements 20 are pressed to disengage the engaging portions 23 from the engaging recesses 522. The electrical plug connector 80 is then pulled upward to detach from the electrical receptacle connector 90.

The guiding pillars 121 are directly formed on the insulated housing 10, and the guiding recesses 521 are directly formed in the receptacle insulated housing 50. Therefore, the aforesaid effect can be achieved by simply attaching the two elastic buckle elements 20 to the plug insulated housing 10, so that the construction of the instant disclosure can be effectively simplified and thus the production cost can be reduced.

The electrical plug connector 80 is applied for connecting a coaxial cable and the electrical receptacle connector 90 is applied for connecting a circuit board or a substrate, and more specifically for use as a Type-C or other types of electrical connectors in a notebook computer. In this embodiment, the pin definition table of the plug terminal 30 of the electrical plug connector 80 and the receptacle terminals 60 of the electrical receptacle connector 90 is as follows:

| | CABLINE-VSII 30P | | | |
|---|---|---|---|---|
| No. | coaxial | | cable | Signal |
| 1 | COAX | <--> | COAX | Reserved |
| 2 | COAX | <--> | COAX | Reserved |
| 3 | COAX | <--> | COAX | Reserved |
| 4 | COAX | <--> | COAX | FORCE_PWR_GPIO |
| 5 | COAX | <--> | COAX | I2C_INT |
| 6 | COAX | <--> | COAX | SMBUS_SCL |
| 7 | COAX | <--> | COAX | SMBUS_SDA |
| 8 | GND | | GND | GND |
| 9 | COAX | <--> | COAX | SSTXp2 |
| 10 | COAX | <--> | COAX | SSTXn2 |
| 11 | GND | | GND | GND |
| 12 | COAX | <--> | COAX | SSRXp2 |
| 13 | COAX | <--> | COAX | SSRXn2 |
| 14 | GND | | GND | GND |
| 15 | COAX | <--> | COAX | USB2_D− |
| 16 | COAX | <--> | COAX | USB2_D+ |
| 17 | GND | | GND | GND |
| 18 | COAX | <--> | COAX | SSRXn1 |
| 19 | COAX | <--> | COAX | SSRXp1 |
| 20 | GND | | GND | GND |
| 21 | COAX | <--> | COAX | SSTXn1 |
| 22 | COAX | <--> | COAX | SSTXp1 |
| 23 | GND | | GND | GND |
| 24 | COAX | <--> | COAX | AUX+ |
| 25 | COAX | <--> | COAX | AUX− |
| 26 | COAX | <--> | COAX | LSTX |
| 27 | COAX | <--> | COAX | LSRX |
| 28 | COAX | <--> | COAX | Reserved |
| 29 | COAX | <--> | COAX | Reserved |
| 30 | COAX | <--> | COAX | Reserved |

The terminals numbers 4 to 7 and 24 to 27 may be adjusted to other signals or uses as required. The terminals numbers 8 to 23 are generally separated by five ground terminals to form five sets of signal terminals, wherein the terminals numbers 9,10,12,13,18,19,21,22 are four sets of high-speed signal terminals, and the terminals numbers 15,16 are one set of low-speed signal terminals.

Even though numerous characteristics and advantages of the instant disclosure have been set forth in the foregoing description, together with details of the structure and function of the instant disclosure, the disclosure is illustrative only, and changes may be made in detail, especially in matters of shape, size, and arrangement of parts within the principles of the instant disclosure to the full extent indicated by the broad general meaning of the terms in which the appended claims are expressed.

What is claimed is:

1. An electrical plug connector comprising:
an insulated housing extending in a long-and-thin shape along a connector longitudinal direction of the electrical plug connector and having
a terminal portion having a first end and a second; and
two connecting portions respectively formed at the first end and the second end of the terminal portion, wherein each connecting portion has a guiding pillar protruding from the connecting portion and having an opening; and a receiving groove formed in the connecting portion and communicating with the opening;
two elastic buckle elements respectively mounted in the receiving grooves of the two connecting portions, wherein each elastic buckle element has a fixed portion mounted at a corresponding one of the connecting portions, a moving portion connected with a top end of the fixed portion, and an engaging portion protruding from a bottom end of the moving portion and selectively extending from the opening of the guiding pillar of a corresponding one of the connecting portions according to the position of the moving portion; and
multiple plug terminals arranged on the terminal portion of the insulated housing along a longitudinal direction of the terminal portion so as to form multipolar shapes at appropriate pitch intervals.

2. The electrical plug connector as claimed in claim 1, wherein the opening in the guiding pillar of each connecting portion is located at a horizontal side surface of the guiding pillar of the connecting portion.

3. The electrical plug connector as claimed in claim 1, wherein the opening in the guiding pillar of each connecting portion is located on a lateral outer side of the guiding pillar of the connecting portion, and the engaging portion of each of the elastic buckle elements protrudes laterally outwards from the bottom end of the moving portion of the elastic buckle element.

4. The electrical plug connector as claimed in claim 1, wherein each connecting portion has a notch formed through a side surface of the connecting portion and communicating with the receiving groove in the connecting portion and each elastic buckle element has a pressing portion protruding from an outer side surface of the moving portion of the elastic buckle element, and extending out of the notch of a corresponding one of the connecting portions.

5. The electrical plug connector as claimed in claim 1, wherein each connecting portion has a fixing groove formed in the connecting portion and the fixed portion of each elastic buckle element is mounted at a corresponding one of the connecting portions and has a side surface and multiple abutting protruding portions protruding from the side surface of the fixed portion and abutting an inner surface of the fixing groove of a corresponding one of the connecting portions.

6. The electrical plug connector as claimed in claim 1, wherein the guiding pillar of each connecting portion has multiple inclined faces formed at a bottom surface of the guiding pillar and is tapered from a top to a bottom of the guiding pillar.

7. The electrical plug connector as claimed in claim 1, wherein the electrical plug connector has a plug metallic shell made of metal and mounted around the insulated housing.

8. The electrical plug connector as claimed in claim 7, wherein the plug metallic shell includes
a first metallic shell having
two side ends;
two first positioning sheets protruding respectively from the two side ends and extending toward the insulated housing; and
two first positioning blocks protruding respectively from top surfaces of the first positioning sheets; and
a second metallic shell having
two side ends;
two second positioning sheets protruding respectively from the two side ends of the second metallic shell and extending toward the insulated housing; and
two second positioning holes formed respectively through the second positioning sheets, and mounted respectively around the first positioning blocks of the first metallic shell.

9. The electrical plug connector as claimed in claim 7, wherein the insulated housing has at least one insertion slot formed in a side surface of the insulated housing and the plug metallic shell has at least one clamping sheet mounted through and fixed with the at least one insertion slot respectively.

10. An electrical receptacle connector adapted to be combined with the electrical plug connector as claimed in claim 1, the receptacle connector comprising:
a receptacle insulated housing extending in a long-and-thin shape along a connector longitudinal direction of the receptacle insulated housing and having
an inserting portion having
a first end;
a second end;
a mounting slot formed in the inserting portion, and the terminal portion of the insulated housing of the electrical plug connector detachably mounted in the mounting slot; and
two receptacle connecting portions respectively formed at the first end and the second end of the inserting portion, each receptacle connecting portion having
a guiding recess formed in a top end of the receptacle connecting portion; and
an engaging recess formed in a side wall of the guiding recess, wherein the two guiding pillars of the electrical plug connector are detachably mounted in the guiding recesses of the two receptacle connecting portions; and
multiple receptacle terminals mounted in the mounting slot of the receptacle insulated housing along the connector longitudinal direction of the inserting portion so as to form multipolar shapes at appropriate pitch intervals.

11. The electrical receptacle connector as claimed in claim 10, wherein the engaging recess of each receptacle connecting portion is located at an outer side surface of the guiding recess of the receptacle connecting portion.

12. The electrical receptacle connector as claimed in claim 10, wherein the electrical receptacle connector has a receptacle plug metallic shell mounted around the receptacle insulated housing.

13. The electrical receptacle connector as claimed in claim 12, wherein the receptacle plug metallic shell has a shelter sheet.

14. The electrical receptacle connector as claimed in claim 13, wherein each receptacle terminal has
an upper extending portion;
a horizontal portion; and
a lower extending portion, wherein the upper extending portion is upwardly bent and formed at a front end of the horizontal portion, and the lower extending portion is bent downwards at a rear end of the horizontal portion; and
the shelter sheet shelters the horizontal portion of each receptacle terminal.

15. The electrical receptacle connector as claimed in claim 12, wherein the receptacle plug metallic shell has
two engaging sheets protruding from the receptacle plug metallic shell and respectively mounted in the two guiding recesses of the receptacle insulated housing, and each engaging sheet having
an engaging hole formed through the engaging sheet; and
the two elastic buckle elements are respectively and detachably engaged with the engaging holes of the two engaging sheets.

16. The electrical receptacle connector as claimed in claim 12, wherein
each receptacle connecting portion has
a housing positioning block protruding from a side surface of the receptacle connecting portion; and
a positioning groove formed in the side surface of the receptacle connecting portion;
the receptacle plug metallic shell includes a third metallic shell and a fourth metallic shell;
the third metallic shell has
two side surfaces;
two third positioning sheets protruding respectively from the two side surfaces of the third metallic shell; and
two third positioning holes respectively formed through the two third positioning sheets; and
the fourth metallic shell has
two side surfaces;
two fourth positioning sheets respectively inserted into the positioning grooves of the two receptacle connecting portions; and
two fourth positioning blocks respectively protruding from side surfaces of the two fourth positioning sheets, wherein
the two third positioning holes are respectively disposed around the housing positioning blocks and the fourth positioning blocks.

17. The electrical receptacle connector as claimed in claim 12, wherein the receptacle insulated housing has at least one receptacle inserting recess formed in a side surface of the receptacle insulated housing and the receptacle metallic shell has at least one fixing sheet protruding from the receptacle plug metallic shell and toward the receptacle insulated housing, and the at least one fixing sheet inserted respectively into the at least one receptacle inserting recess.

18. The electrical receptacle connector as claimed in claim 12, wherein the receptacle plug metallic shell has at least one grounding sheet protruding from the receptacle plug metallic shell.
